(19) United States
(12) Patent Application Publication
(10) Pub. No.: US 2018/0004723 A1
(43) Pub. Date: Jan. 4, 2018

(54) DYNAMIC WEB DOCUMENT CREATION

(71) Applicant: Hearsay Social, Inc., San Francisco, CA (US)

(72) Inventors: Jordan Eldredge, San Francisco, CA (US); Daniel Tucker, Oakland, CA (US); Caroline Wong, San Francisco, CA (US)

(21) Appl. No.: 15/197,347

(22) Filed: Jun. 29, 2016

(51) Int. Cl. G06F 17/24; G06F 17/22; G06F 17/30; G06F 3/0482; H04L 29/08

(52) U.S. Cl. CPC G06F 17/248; G06F 17/30312; G06F 17/30589; G06F 3/0482; G06F 17/243; G06F 17/2247; H04L 67/02

(57) ABSTRACT

A user selection of one or more nodes of a hierarchical data structure is received. A plurality of available tokens associated with the one or more selected nodes based at least in part on metadata associated with the plurality of elements is determined. A plurality of character lengths corresponding to the plurality of available tokens is determined. A user input of content for a field in a template is received where the field is associated with a character count limit and the user input comprising at least one of the determined plurality of available tokens. A character count associated with the user input is dynamically updated. A plurality of documents is to be composed where the plurality of documents corresponds to the plurality of elements associated with the one or more selected nodes.

### BACKGROUND OF THE INVENTION

An organization may have tens, hundreds, even thousands of employees (e.g., agents, representatives, etc.), each of which has an online presence and can publish content on behalf of the organization. To facilitate the dissemination of information by its employees, the organization may wish to create a web document that is suitable for publication on a website associated with each of the employees. The organization may wish the content of the web document to deliver a uniform message, but at the same time, include certain personal information of the employee publishing (e.g., a publisher user) the message to make the message more appealing to the readers of the message. However, manually personalizing a message for all the employees who may publish the message can be a task that is difficult, inefficient, and time consuming to perform. Currently, automatic personalization, such as inserting the employee's name into a message, can result in errors because websites to which the content is posted often have requirements regarding the formats of various fields within the web document. A better technique to personalize messages is needed.

### BRIEF DESCRIPTION OF THE DRAWINGS

Various embodiments of the invention are disclosed in the following detailed description and the accompanying drawings.

FIG. 1 is a functional diagram illustrating a programmed computer system for dynamic web document creation in accordance with some embodiments.

FIG. 2 is a block diagram illustrating a system that dynamically creates web documents.

FIG. 3A is a diagram showing an embodiment of a hierarchical data structure.

FIG. 3B is a diagram showing an embodiment of entries associated with elements.

FIG. 4A is a flow chart illustrating an embodiment of a process to dynamically create web documents.

FIG. 4B is a flow chart illustrating an embodiment of a process to publish web documents.

FIG. 5A illustrates an example screen displaying a node selection screen, in which nodes can be selected.

FIG. 5B illustrates an example screen displaying nodes that are available for a workspace.

FIG. 6A illustrates an example screen of a template that allows a user to customize the content of the web document.

FIG. 6B illustrates an example screen of a template that has received an error notification.

FIG. 7 illustrates an example of a review and publish screen.

FIGS. 8A and FIG. 8B illustrate examples of content created for elements of a selected node.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An efficient web document creation technique is disclosed.

Creating a web document for multiple employees of an organization that not only conforms to the length constraints of a web document, but also includes certain personal information of an employee imposes several challenges because the character length associated with employee information is often unpredictable. It would be useful to create a system that allows an organization to create a web document for a website associated with each of its employees that conforms to the website's character length constraints, delivers a uniform message, and includes personal information of the employee.

In some embodiments, a hierarchical data store stores information associated with every element of an organization. An element of an organization may correspond to an individual doing work for the company, such as an agent, an employee, an administrator, a creator user, a publisher user, an independent contractor, or any other appropriate individual associated with the organization. An element can include entry information such as name, address, phone number, or any other appropriate attribute information associated with the element. In some instances, the amount and type of information associated with the elements can be different for different elements. For example, the hierarchical data store may store detailed information about a particular element while at the same time store less information about a different element. However, in some instances, an organization may desire to create a web document that delivers a uniform message and is suitable for both elements. This creates problems because the organization may want to create a message that includes certain personal information, but for one of the elements, the personal information is unknown.

To determine information that is common to both elements, the system can compute an intersection of the information to find entries that are common to both elements. The elements that are common to both elements are stored in the hierarchical data store.

An organization may be comprised of a plurality of nodes (e.g., a region node, a department node, a state node, a city node, a function node, an account node, etc.) that divide the elements of the organization into different groups. A node is a set of one or more elements of an organization. For example, an “engineering” department node may be comprised of all the elements of an organization that are associated with the engineering department. An element may be a part of more than one node. For example, an element may be part of a “west” region node and part of a “sales” department node. The larger an organization, the more complex it becomes to create a web document that is both personalized for all the elements of a node and suitable for publishing. Creating a web document becomes even more complex when a web document is to be created for multiple nodes. For example, a first node may be comprised of 1000 employees and a second node may be comprised of 2000 employees. The web document may be created for an intersection of the first node and the second node or a union of the first node and the second node. The number of employees and the entries that are common to the employees vary depending on which nodes are selected. The amount of information about each individual that is stored in the hierarchical data store is not the same. For example, some of the employees may have ten entries of profile information about them stored in the hierarchical data store while others may have twenty entries of profile information. For the employees that have ten entries of profile information about them stored in the hierarchical data store, the ten entries of information are not necessarily the same (for example, one employee has a “license number” entry that another employee does not have).

Keeping track of the entries that are common to all elements of a node is a resource intensive process because the elements of an organization and information known about the elements change over time. The entries that are common to all elements of a node(s) are stored in the metadata of the node and periodically updated. For example, the entries that are common to all elements of a node(s) may be updated on an hourly basis, daily basis, weekly basis, monthly basis, or any other interval that is commensurate with the frequency to which the information associated with elements or the elements within a node undergo change. To determine entries that are common to all elements of a plurality of nodes, an intersection of the nodes is computed in some embodiments.

A dynamic web document creation interface can be provided to a creator user (e.g., a system administrator or the like tasked with generating the web document) through a web browser, a standalone application, or other appropriate components. A creator user may select one or more nodes of an organization for which a web document is to be created. Based on the selected nodes, the entries common to each element of the selected nodes are determined. The interface displays one or more tokens that correspond to entries that are common to the elements of the selected nodes. Each of the one or more tokens has an associated character count length. The associated character count length is based on the entry value of the intersection of entries that has a longest character length.

In some embodiments, to compose a web document, a creator user is provided with a template that includes one or more fields. Each of the fields has an associated character count limit. The template and/or the character count limit of each field is specified by the website to which the web document is posted. The creator user may input text or an available token into a field. As a creator user inputs tokens and text into a field of the template, a character count associated with the creator user input is dynamically updated based on a character length of the inputted text and a character length of the inputted tokens. The character count limit associated with each field places limitations on the types of messages that may be created for all elements of a node because while the number of characters associated with the inputted text is readily ascertainable, it is a very cumbersome process to determine a character length for the inputted token. For example, a field may have a character length restriction of thirty characters. For a particular field, a user may attempt to create a resulting message of “Hi, my name is {first name} {last name}!” The length of the text is seventeen characters (including spaces, excluding the quotation marks), but the length of the characters associated with the tokens “{first name}” and “{last name}” are unknown. For some elements, the character length of corresponding names will exceed thirteen characters while for other elements, the character length of corresponding names will not exceed thirteen characters. If the character count limit is exceeded, the creator user will be notified so he may modify the text of the field to ensure that for all elements of the selected nodes, the resulting message complies with the character count requirements of that field. For example, the creator user may change “my name is” to “I am” to reduce the character count. Since the entry values associated with entries of an element are stored in the hierarchical data store, the maximum character length associated with common entries may be precomputed. This allows a creator user to efficiently create a web document for all elements of one or more selected nodes because a user is able to create a web document that is compatible with all elements instead of having to create a web document that is compatible with some of the elements and a different web document that is compatible with the other elements.

When all of the fields have been completed and the character count limit for each of the fields has not been exceeded, then a web document is composed for each of the elements of the one or more selected nodes. The web document is reviewed and subsequently published to a website that is associated with each element.

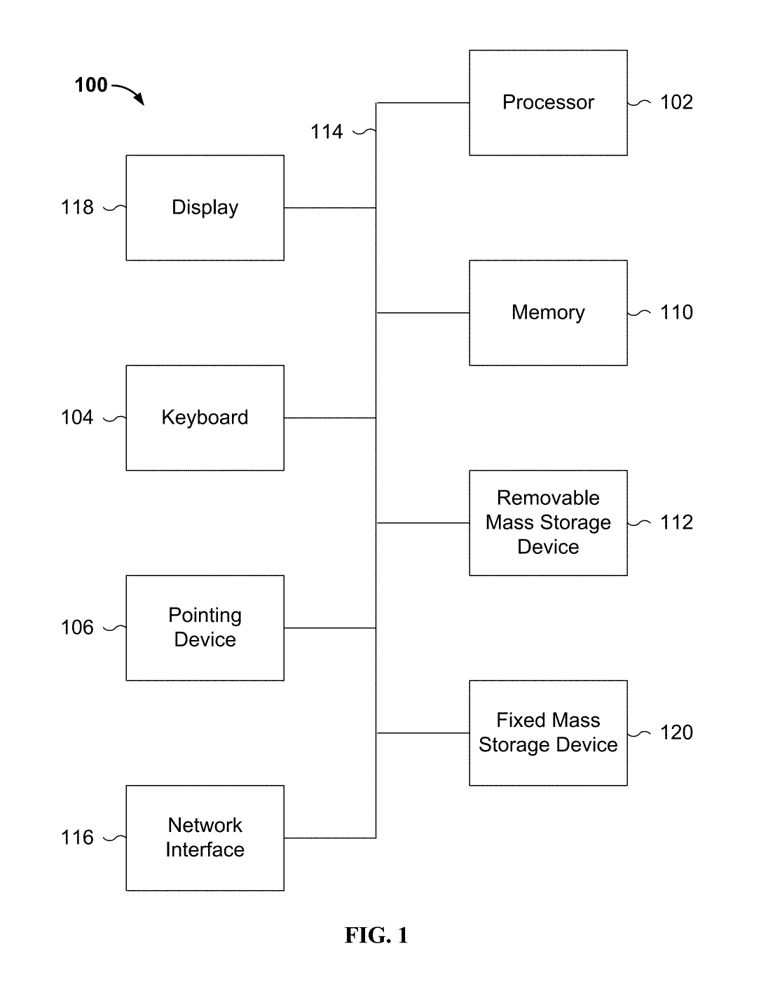

FIG. 1 is a functional diagram illustrating a programmed computer system for dynamic web document creation in accordance with some embodiments. As shown, FIG. 1 provides a functional diagram of a general purpose computer system programmed for web document creation in accordance with some embodiments. As will be apparent, other computer system architectures and configurations can be used to create dynamic web documents. Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display 118.

Processor 102 is coupled bi-directionally with memory 110, which can include a first primary storage, typically a random access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data, and objects used by the processor 102 to perform its functions, for example programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown.

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks in conjunction with a remote processor that shares a portion of the processing. Throughout this specification, “network” refers to any interconnection between computer components including the Internet, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, WiFi, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous, heterogeneous systems and/or groups of systems together. Additional mass storage devices, not shown, can also be connected to processor 102 through network interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example, a script that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

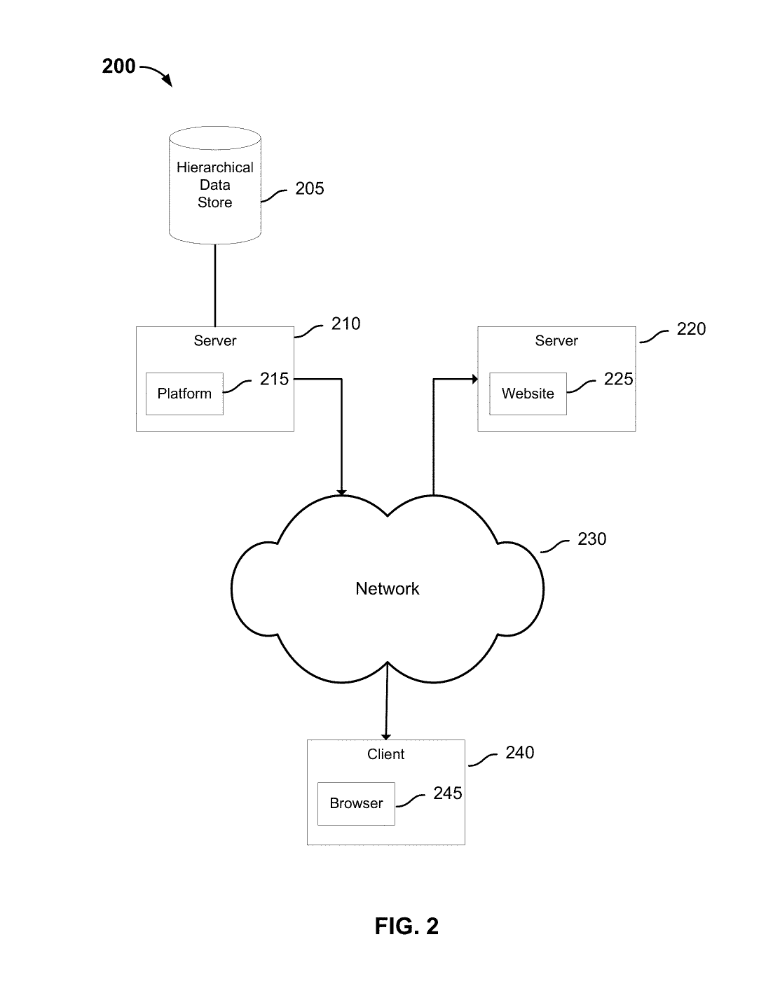

FIG. 2 is a block diagram illustrating a system that dynamically creates web documents. In the example shown, the system 200 includes a platform server 210 that executes a dynamic web document creation platform 215 and is connected to a hierarchical data store 205, a web server 220 that hosts a third party website 225, a network 230, and a client computing system 240 that includes a web browser or standalone application 245. For example, a creator user may use client computing system 240 to create a web document to be published on a website 225, such as Facebook® or other social networking websites, via the platform 215, such as Hearsay Social®'s management platform.

The hierarchical data store 205 stores information associated with one or more elements of an organization and information associated with one or more organizations. The hierarchical data store 205 stores information about different nodes within an organization and the elements that comprise each node. For each element, the hierarchical data store 205 stores entries associated with each element and corresponding entry values. The entries correspond to certain personal information that is associated with an element. The hierarchical data store may be a memory and/or storage device internal to the server 210, a memory and/or storage device attached to the server 210, or any memory and/or storage device connected to the server 210 via a network connection. The network connection may be a wired or wireless connection.

The server 210 executes a dynamic web document creation platform 215. The server 210 may be implemented using one or more computing devices such as a computer, a multi-processor system, a microprocessor-based system, a special purpose device, a distributed computing environment including any of the foregoing systems or devices, or other appropriate hardware/software/firmware combination that includes one or more processors, and memory coupled to the processors and configured to provide the processors with instructions.

The platform 215 is accessible by a browser (or other client application) 245 via network 230. The platform 215 allows a creator user to create a web document for any node within an organization. A user interface is provided to the creator user via the browser (or other client application) 245 to select one or more nodes within the organization for which the web document is created. A web document template is provided to the creator user at the browser (or other client application) 245 and the creator user is able to modify the web document template via the browser (or other client application) 245. The platform 215 composes the web document based on inputs provided by a creator user of browser (or other client application) 245. After the web document has been reviewed, the platform 215 publishes the web document to a website associated with each element of a node(s) selected by the creator user using Application Programming Interfaces (APIs) provided by the website (e.g., Facebook® Marketing API). Examples of websites associated with an element include a Facebook® profile of a publisher user, a Twitter® feed of the publisher user, a Yelp® account of the publisher user, a LinkedIn® profile of the publisher user, etc. Examples of web documents include an article, a social media website post (e.g., a posting on Facebook®, a tweet on Twitter®, a recommendation on LinkedIn®, a review on Yelp®, etc.), a sponsored story, an advertisement, a deal for a certain product, an application, etc. The website may format the composed web documents for the device that will view the web document. For example, the web documents can be formatted for a desktop computer and a mobile device. The website may also publish the composed web document in different formats. For example, a composed web document may be formatted to appear in a Facebook® news feed or as a Facebook® right column content item. The website can control how the web document will appear on the website. For example, the entire text of a field may be capitalized on the website even though the text was entered into the web document template using lower case letters. In some embodiments, the website can also control the amount of space reserved for a text field, the placement of the field within the web document, the font used in the web document, and the size of image to be used in a web document. In some embodiments, the website can resize a selected image to conform to its specifications.

Network 230 connects server 210 to client 240 and one or more servers 220 hosting websites 225. Network 230 comprises one or more of the following: a local area network, a wide area network, a wired network, a wireless network, the Internet, an intranet, or any other appropriate communication network.

Client device 240 includes a web browser or other client application 245 that is accessible by a user of the client device 240. Examples of client device 240 include a computer, a laptop, a desktop, a tablet, a mobile device, a PDA, or any other device that operates a web browser or client application.

Server 220 hosts a website 225 associated with an element. Server 220 may be implemented using one or more computing devices such as a computer, a multi-processor system, a microprocessor-based system, a special purpose device, a distributed computing environment including any of the foregoing systems or devices, or other appropriate hardware/software/firmware combination that includes one or more processors, and memory coupled to the processors and configured to provide the processors with instructions. An element may be associated with a plurality of websites. For example, an element may be associated with a Facebook® account, a Twitter® account, a LinkedIn® account, a Google+® account, etc. Each of the plurality of websites may be associated with a different server. In some embodiments, website 225 is a third party website hosted by a plurality of servers 220. For example, website 225 can be a social networking site such as Facebook®, Twitter®, LinkedIn®, Yelp®, etc., and server 220 is one of the web servers hosting webpages and/or other services for the website.

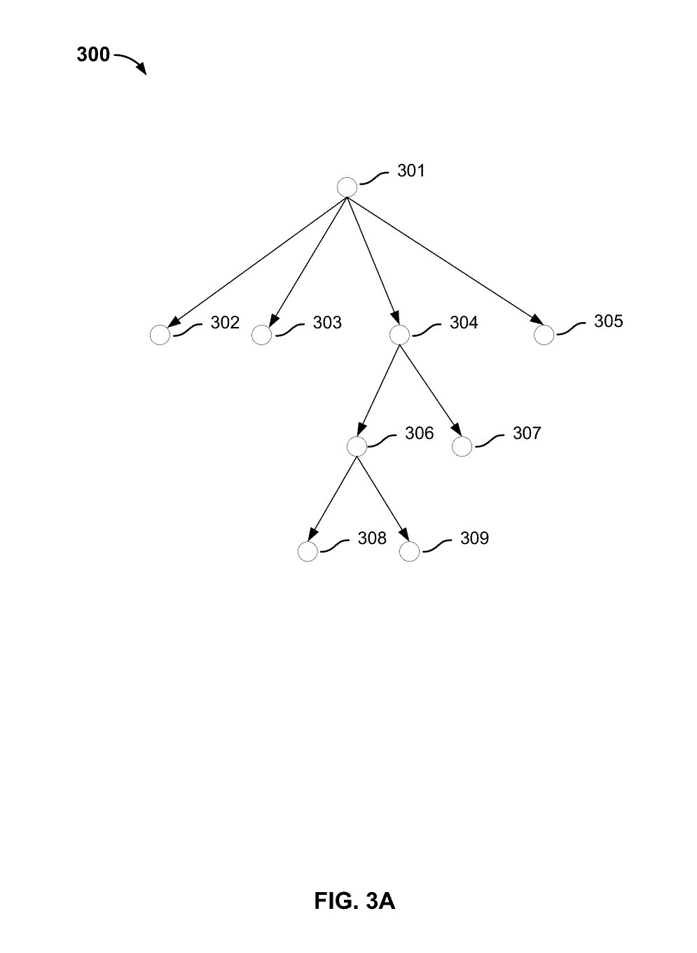

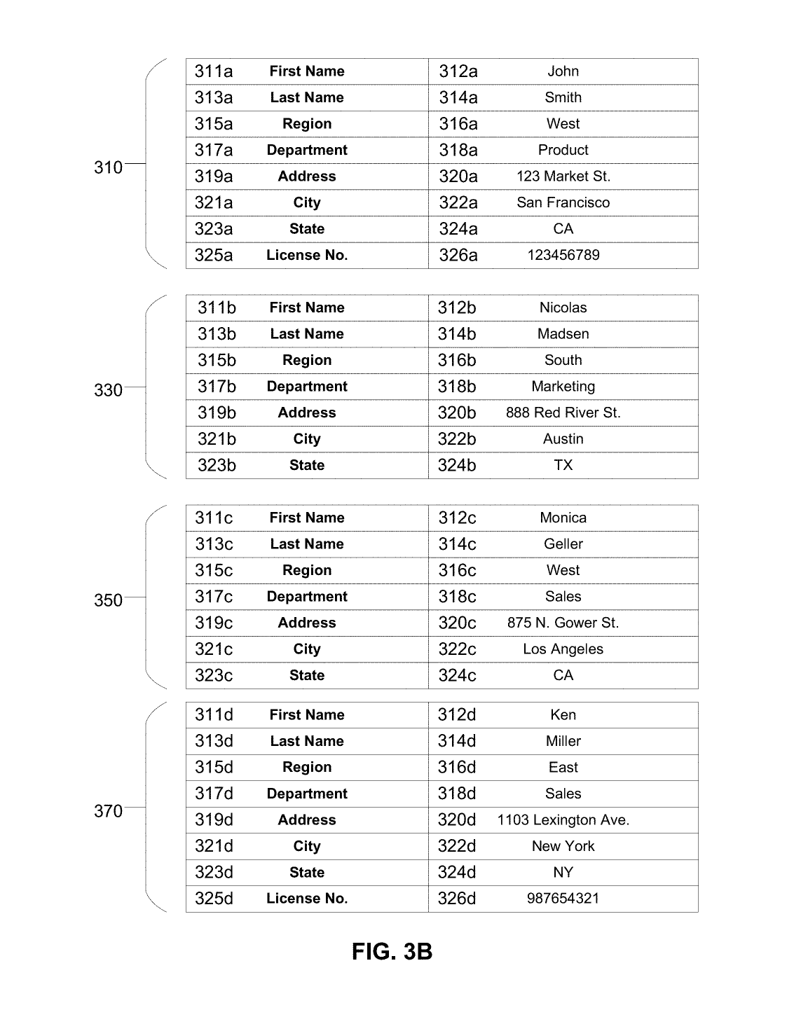

FIG. 3A is a diagram showing an embodiment of a hierarchical data structure. In some embodiments, the hierarchical data structure is stored in the hierarchical data store 205. In the example shown, the hierarchical data structure 300 includes nodes 301, 302, 303, 304, 305, 306, 307, 308, 309. A node corresponds to a set of elements within an organization. For example, a node may correspond to all elements located in a geographical division of an organization, e.g., West, East, South, and North. In the example shown, nodes 302, 303, 304, and 305 may correspond to region nodes “West,” “East,” “South,” and “North,” respectively. A node may correspond to all elements in a particular department of an organization, e.g., sales, marketing, product development, research and development, engineering, etc. A node may correspond to any appropriate grouping of elements of an organization. An element of an organization may correspond to an agent, an employee, a creator user, a publisher user, an independent contractor, or any appropriate individual associated with the organization. In some embodiments, the nodes for which a web document is to be created are selectable via a user interface of the browser (or other client application) 245.

An element may be associated with one or more nodes of the organization. The dynamic web document creation platform is capable of composing a web document for one or more selected nodes. For example, a web document may be created for elements that are part of a west division of the organization and also a part of the sales department. This allows an organization to create a web document for a specific segment of its employees.

FIG. 3B is a diagram showing an embodiment of entries associated with elements. The example specifically illustrates entries associated with elements 310, 330, 350, and 370. Elements 310, 330, 350, and 370 may be associated with one or more nodes shown in FIG. 3A. In the example shown, each entry has an associated entry value. The entries represent information about an element that has been provided to the hierarchical data store. For example, element 310 has a first name entry 311a and an associated entry value 312a, a last name entry 313a and an associated entry value 314a, a region entry 315a and an associated entry value 316a, a department entry 317a and an associated entry value 318a, an address entry 319a and an associated entry value 320a, a city entry 321a and an associated entry value 322a, a state entry 323a and an associated entry value 324a, and a license number entry 325a and an associated entry value 326a, etc. Elements 330, 350, and 370 each have corresponding entries and entry values. In some embodiments, the entry and associated entry values are stored as key-value pairs in the hierarchical data store. In the example shown, the information associated with each element is not necessarily the same across each element. For example, elements 310 and 370 have a “License No.” entry and associated entry value whereas elements 330 and 350 do not have a “License No.” entry and associated entry value.

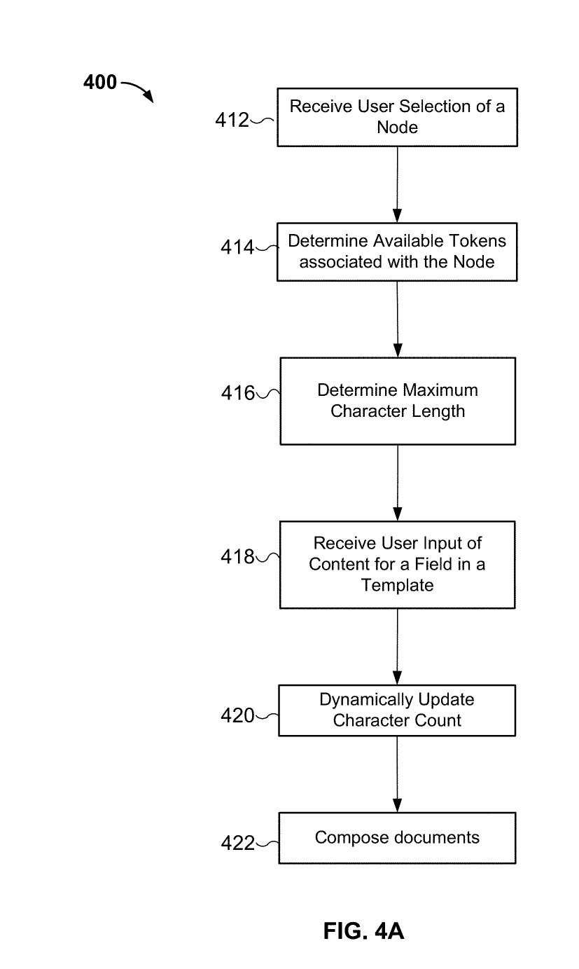

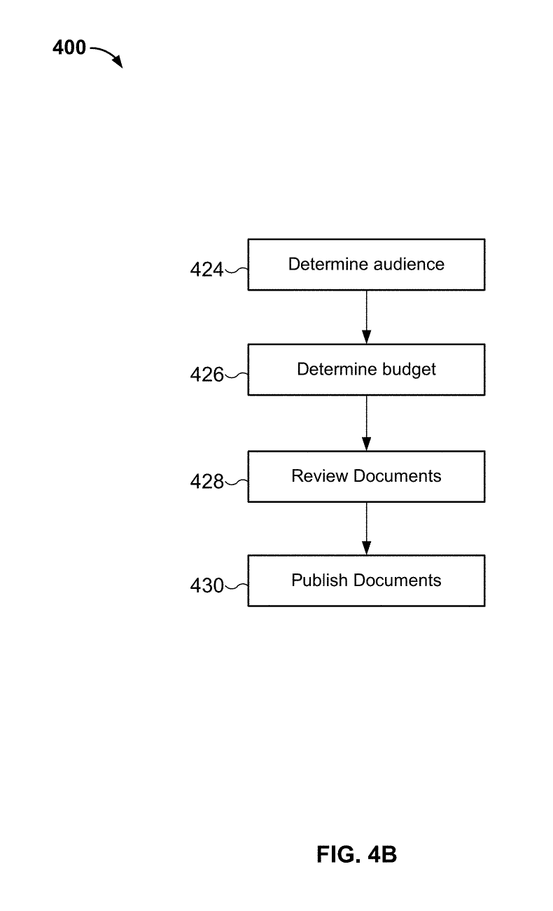

FIG. 4A is a flow chart illustrating an embodiment of a process to dynamically create web documents. In some embodiments, the process 400 of FIG. 4A is executed by a dynamic web document creation platform (e.g., platform 215 of FIG. 2) and/or by one or more scripts loaded into a browser (or client application) (e.g., browser 245) of a client system using a system such as 100 of FIG. 1.

At 412, a creator user selection of one or more nodes is received at a web browser of a client system. The creator user may select any of the nodes that an organization has established in the hierarchical data store. For example, the user may select a region node and a department node. The selection is transmitted to the dynamic web document creation platform.

At 414, the available tokens associated with the one or more selected nodes are determined. In some embodiments, the dynamic web document creation platform is configured to determine the available tokens associated with the one or more selected nodes. In other embodiments, one or more scripts are loaded into a browser (or client application) of a client system from the dynamic web document creation platform and configured to determine the available tokens associated with the one or more selected nodes.

As used herein, a token refers to a variable that may be inserted into a field of a web document creation template. A token corresponds to an entry of an element, which has a corresponding entry value. When a web document is created using the web document creation template and a token is inserted into a field of the web document creation template, the token will be replaced with the entry value associated with the entry that corresponds to the token.

To determine the available tokens associated with the one or more selected nodes, the metadata associated with each of the one or more selected nodes is analyzed. The metadata reflects an intersection of all the entries for all of the elements of the selected node(s). The metadata indicates the entries that are common to all of the elements of the one or more selected nodes.

For example, for the elements depicted in FIG. 3B, if a user selects a “West” region node, the metadata would include information pertaining to the intersection of the entries associated with elements 310 and 350 because both elements 310 and 350 have an entry value of “West” associated with the entry “Region.” In the example shown, the metadata for the selected nodes would have information associated with a “First Name” entry, a “Last Name” entry, a “Region” entry, a “Department” entry, an “Address” entry, a “City” entry, and a “State” entry. The metadata for the “West” region node would not reflect the entries associated with elements 330 and 370 because they are associated with the “South” and “East” region nodes, respectively. In some embodiments, a node can specify which elements are included by pointing to the element's object addresses, referencing the elements by ID, etc.

The available tokens correspond to the entries that are common between the elements (in other words, the intersection of entries for the elements). For example, for the elements depicted in FIG. 3B, suppose that a “West” region node is selected, and elements 310 and 350 are associated with this node. The available tokens correspond to a “First Name” entry, a “Last Name” entry, a “Region” entry, a “Department” entry, an “Address” entry, a “City” entry, and a “State” entry of element 310 and element 350. A token associated with the “License No.” entry 325a would not be available because element 350 does not have a corresponding “License No.” entry.

The elements of an organization may change over time. For example, an element may leave the organization, become a part of a new node, leave a node, and/or add or remove another entry to its entries. The available token determination by the dynamic web document creation platform is computed and updated on a regular basis and the results of the computation are stored in the hierarchical data store. For example, the determination may be precomputed on an hourly basis, daily basis, weekly basis, monthly basis, or any other interval that is commensurate with the frequency to which the information associated with elements or the elements within a node undergo change. For example, an element may be added or removed from a node. In other instances, an entry and associated entry value may be added or removed from information associated with an element. In other embodiments, the available token determination is computed when a user selects one or more of the nodes.

At 416, the maximum character length of each entry for a set of entry values is determined. In some embodiments, the dynamic web document creation platform is configured to determine the maximum character length of each entry for a set of entry values. In other embodiments, one or more scripts are loaded into a browser (or client application) of a client system from the dynamic web document creation platform and configured to determine the maximum character length of each entry for a set of entry values.

A token has an associated length that is based on a length of an entry value. For example, a token of “{last_name}” corresponds to entry 313a of element 310 and entry 313c of element 350. The length of the token depends on a character length of all entry values within a node. For example, for the elements depicted in FIG. 3B, if a country node “United States” includes elements 310, 330, 350, and 370, the token “{last_name}” would have a character length of six because the longest last name in the node of elements 310, 330, 350, and 370 is a tie between Madsen, Geller, and Miller.

At 418, creator user input of content for a field in a template is received at a web browser (or other client application) of a client system. The creator user input may include an available token, text, a URL, or a link to a file. The template is used to compose a document for a website. In some embodiments, the website provides a template with associated fields. For example, the template may include a headline field, a body text field, a news feed link description field, a display link field, and an image field. Each field of the template has an associated character length limit. For example, the body text field may have a character length limit such that the user input may not exceed 140 characters. In some embodiments, the character length limit is specified by the website to which the content is to be posted.

At 420, the available number of characters for a field is dynamically computed in real time as a creator user enters input into the field. The available number of characters for a field may be dynamically computed in real time by the browser (or other client application) of the client device via one or more scripts loaded to the browser (or other client application) from the dynamic web document creation platform. For each field of a web document template, the one or more scripts that are loaded to the browser (or other client application) determine a maximum character count, a current character count, and/or a remaining character count.

As a creator user enters a character into the field, a character count is updated. In some embodiments, the character count indicates the total number of characters inputted by the user. In other embodiments, the character count indicates a number of remaining characters available for that particular field. In other embodiments, the character count indicates a ratio between a number of remaining characters available for that particular field to the total number of characters available for that field. In other embodiments, the character count indicates a ratio between the number of characters inputted by the user to a total number of characters available for that particular field. In other embodiments, the character count indicates a number of characters inputted by the user that exceeds a character count limit. In other embodiments, the character count indicates a ratio between the number of characters inputted by the user that exceeds a character count limit to a total number of characters inputted by the user. In some embodiments, when the number of characters entered by the user exceeds a character count limit, the character count corresponds to a negative value (e.g., number of characters by which the limit is exceeded).

When a user inputs an available token into the field of the template, the character count is dynamically computed based on the character length associated with the inputted available token. For example, braces { } are used to delineate the name of the token. A creator user may enter an available token of “{last_name}” into a field of the template. The string of “{last_name}” has a character length of 11. As the user enters the token “{last_name” into the field, the character count is updated as if the user was entering in regular text. However, when the user finishes entering in the token by typing the } character, it is detected that the name of an available token has been entered and the character count is updated to reflect an actual character count. For example, if the “West” region node is selected, elements 310 and 350 are associated with the “West” region node. In the example provided, the maximum character length for the “Last Name” entry between element 310 and element 350 is six (“Geller”). As a result, the character count is updated to reflect that token “{last_name}” uses six characters instead of the character length of “{last_name}”, which is eleven.

At 422, a plurality of web documents is caused to be composed for each of the elements of the selected node(s). For each web document, the entry value of an entry that corresponds to the available token is inserted into the web document. In response to receiving the information inputted into the web document template, the dynamic web document creation platform is able to compose a web document using the inputted information.

FIG. 4B is a flow chart illustrating an embodiment of a process to publish web documents. In some embodiments, the process of FIG. 4B is executed by a web document creation platform (e.g., platform 215 of FIG. 2) using a system such as 100 of FIG. 1.

At 424, an audience associated with the composed web documents is received by the dynamic web document creation platform after a creator user inputs into a user interface associated with the browser (or other client application) the audience associated with the composed web documents. The dynamic web document creation platform receives the audience information and updates the audience to which the composed web documents will be published. Each element may be associated with a specific location and the creator user may desire to target specific areas with the web document. This information is used to determine who the website should target for the web content on its website. In some embodiments, the audience may correspond to a radial distance associated with an address of the element. In other embodiments, the audience may correspond to a particular geographical location (e.g., zip code, area code, state, county, voting district, school district, etc.) associated with an address of the element.

At 426, a budget associated with publishing the web documents is specified by the creator user and received at the interface. The dynamic web document creation platform receives the budget information and publishes the composed web documents based on the specified budget. For example, budget information, such as how much money can be spent on publishing the web document and the period of time that money can be spent on publishing the web document can be established. For each node, the budget may determine the frequency to which the web document is published to the website. For example, for a selected node, the web document may be published on an hourly, daily, weekly, monthly, or any other predetermined basis.

At 428, the composed web documents are presented to the creator user to be reviewed via the browser (or other client application). The system determines whether additional elements have been added to the one or more selected nodes since the plurality of web documents was composed. For example, one or more employees may have been added to a node since the web document was composed. If there are additional elements, the system determines if the composed web documents are compatible with the entries and entry values associated with the additional element. For example, prior to the additional element being added to a node, the body of a text field in the template may use all of the total number of characters available for that particular field. However, composing a web document for the additional element may cause the character count for that particular field to exceed the character count limit associated with that particular field. For example, a text field may have a character limit of 30 characters. A creator user may select a country node of “United States,” which includes elements 310, 330, 350, and 370. If the text of the text field is “Hi, my name is {first name} {last name}!”, the text of the text field has reached the character count limit because the non-token text has a character count of seventeen characters, the character length associated with the token text of “{first name}” has a character count of seven characters (“Nicolas”) , and the character length associated with the token text of “{last name}” has a character count of six characters (“Madsen”). If an additional element with the first name “William” and last name “Johnson” was added to the country node after composing the web document, the dynamic web document creation platform would be unable to publish the web document because the text field would not conform to the website requirements (e.g., 17 (non-token text)+7 (first name)+7 (last name)=31). In this instance, the creator user is provided with the option of publishing the web document for all of the other elements of the node. In other embodiments, the creator user is prevented from proceeding to 430 and is provided with the option of modifying the template so that for each element of the one or more selected elements including the additional elements, the character count of the field does not exceed the total number of characters available, such that a web document may be published for each element of the one or more selected nodes. In the event composing a web document for the additional element does not cause the character count for any field to exceed a corresponding character count limit, the web document is composed for the additional elements.

At 430, the composed web documents are published for each element of the one or more selected nodes on a website associated with a publisher user. In some embodiments, the browser (or other client application) executes an API to upload the documents to the webserver at appropriate locations (e.g., as postings in the publisher user's account) to make the documents available to be viewed or downloaded by other browsers and client applications. The API allows the dynamic web document platform to communicate with the website to which it will publish the web document. The API is provided by the website to which the web document will be published and requires certain inputs in order for the web document to be published on the website. For example, the dynamic web document platform may publish the composed documents to Facebook® via the Facebook® Marketing API, which requests that certain inputted fields (e.g., demographics, audience, budget, schedule, etc.) are provided. As a result, Facebook® can publish the composed web document to specified demographics, a specified audience, and according to a specified budget and schedule.

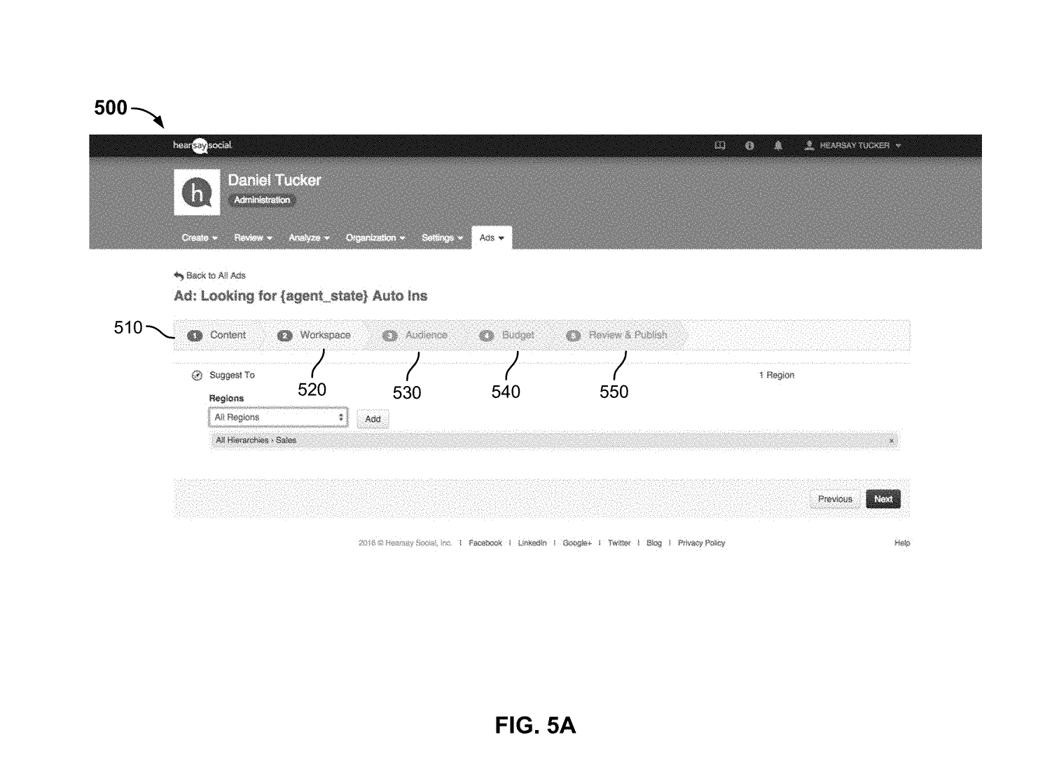

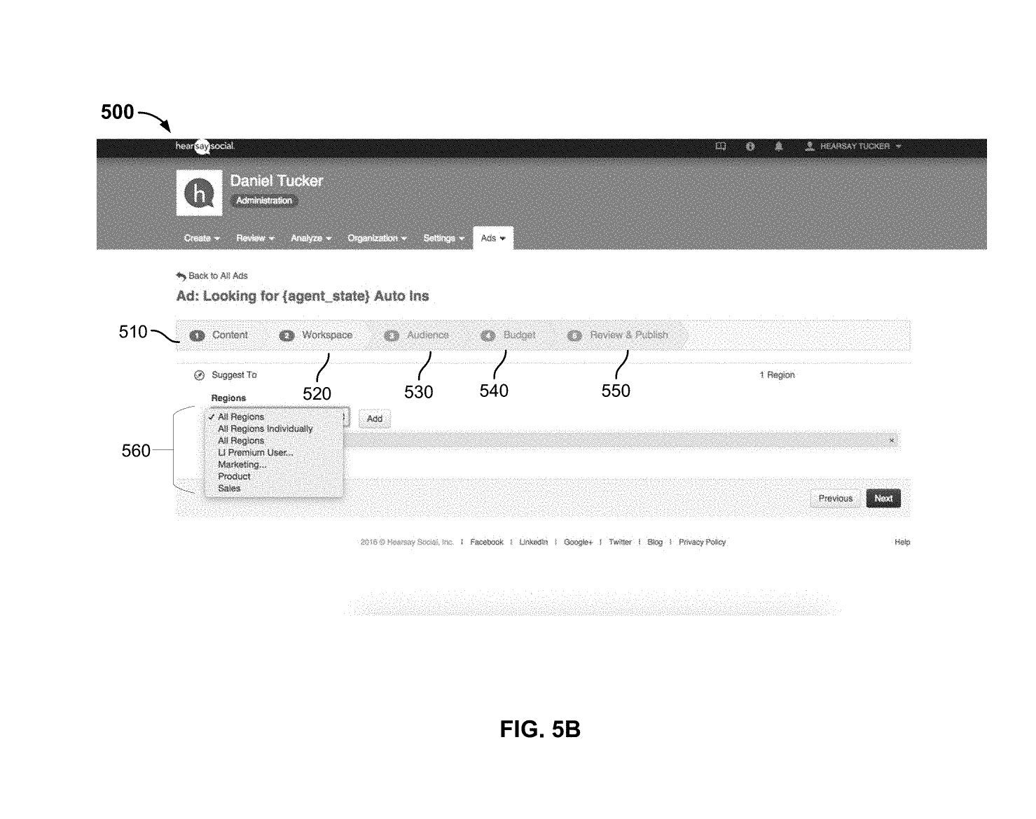

FIG. 5A illustrates an example screen displaying a node selection screen, in which nodes can be selected. In some embodiments, a creator user selects nodes, as described at 412, using a user interface 500 depicted in FIG. 5A. In the example shown, a document creation workflow is depicted. The workflow comprises a series of steps to be performed by the creator user, depicted using labels such as content 510, workspace 520, audience 530, budget 540, and review and publish 550. In the example shown, the workspace 520 is created after content 510 has been entered. A workspace is comprised of one or more selected nodes. In some embodiments, the content 510 is created after the workspace 520 has been established.

FIG. 5B illustrates an example screen displaying nodes that are available for a workspace. In the example shown, any of the nodes 560 may be selected. In some embodiments, when a node is selected, the available tokens associated with the selected node are shown alongside the selected node. For example, if a “West” region node is selected, then the tokens associated with elements 310 and 350 (e.g., “{first name}”, “{last name}”, “{region}”, “{department}”, “{address}”, “{city}”, and “{state}”) are displayed. A user may select any combination of nodes that are available for selection. The available tokens for each combination of nodes are precomputed and stored in the hierarchical data store. The available tokens for each combination of nodes are based on the intersection of entries associated with each element of the one or more selected nodes.

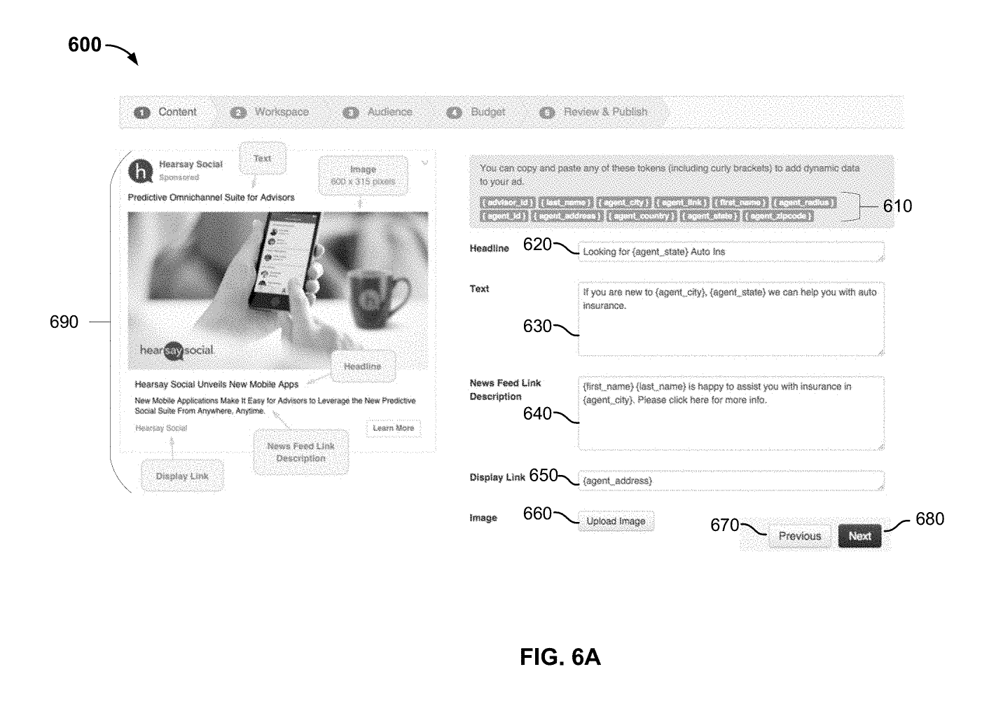

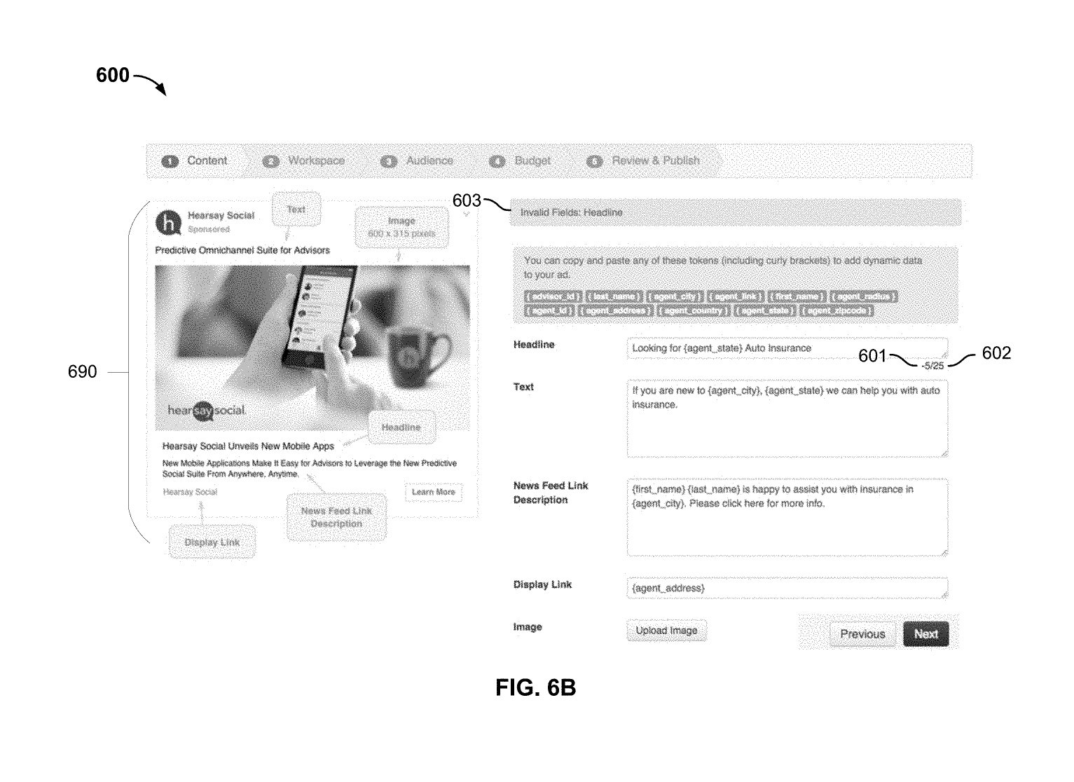

FIG. 6A illustrates an example screen of a template that allows a user to customize the content of the web document. In the example shown, the screen lists a set of available tokens 610 associated with the selected node(s) that are available to be entered into template 600. In some embodiments, these are the tokens that were determined by the web document creation platform at 414. The available tokens 610 correspond to the intersection of entries for elements of one or more selected nodes. In the example shown, all of the elements in the selected node(s) have an entry value associated with the tokens “{advisor_id}”, “{last_name}”, “{agent_city}”, “{agent_link}”, “{first_name}”, “{agent_radius}”, “{agent_id}”, “{agent_address}”, “{agent_country}”, “{agent_state}”, and “{agent_zipcode}”. Some of the elements of the selected nodes may have more entries to which they are associated, but only the tokens that correspond to entries that are common to all of the elements of the selected nodes are displayed. In the example shown, template 600 includes a Headline field 620, a Text field 630, a News Feed Link Description field 640, a Display Link field 650, and an Image field 660. The screen also includes a previous button 670, a next button 680, and a sample 690 of a web document for the website.

The Headline field 620 allows a user to create a headline for the web document. The Text field 630 allows a user to insert input associated with the web document. The News Feed Link Description field 640 allows a user to include a description about the web document. The Display Link field 650 allows a user to include a link to a website associated with an element. For example, the link may be a link to an element's LinkedIn® page or the element's personal website. The Image field 660 allows a user to select an image to be included in the composed web document.

Each of the fields 620, 630, 640, and 650 is associated with a respective character count limit. For example, field 620 may have a character count limit of 30 characters while field 630 may have a character count limit of 140 characters. In some embodiments, the character count limit is established by the website to which the document will be posted. In some embodiments, the fields of the template are established by the website to which the document will be posted.

The sample 690 depicts a sample web document, which illustrates where different fields of the template 600 would appear if the web document is published on the website. In the example shown, the Text field 630 will appear above the image selected via Image field 660. The Headline field 620 will appear below the selected image and the News Feed Link Description field 640 will appear below the Headline field 620. The Display Link field 650 will appear at the bottom of the web document.

FIG. 6B illustrates an example screen of a template that has received an error notification. In the example shown, a character count 601 is displayed when a field is the active field on the display. A creator user inputs text into a field and the character count 601 is dynamically updated by the web document creation platform. In the example shown, a character count 601 has exceeded a character count limit 602 associated with the Headline field 620 due to the combination of non-token characters and the character length associated with the inputted available token exceeding the character count limit 602 associated with the Headline field 620. In the event a character count has exceeded a character count limit associated with a field, an error message 603 is displayed. In some embodiments, the error message 603 is displayed when a user clicks on the next button 680. In other embodiments, the error message 603 is displayed when the field is no longer active, e.g., the user is typing text into a different field or the user has selected a different field. In some embodiments, the error message 603 is displayed in real time as the user is entering in characters into a field. In some embodiments, the character count may change colors in the event the character count has exceeded a character count limit associated with the field. In some embodiments, the character count may change font size in the event the character count has exceeded a character count limit associated with the field. The error message 603 is removed when the text of an invalid field is modified to have a character count that is less than the character count limit for the corresponding field.

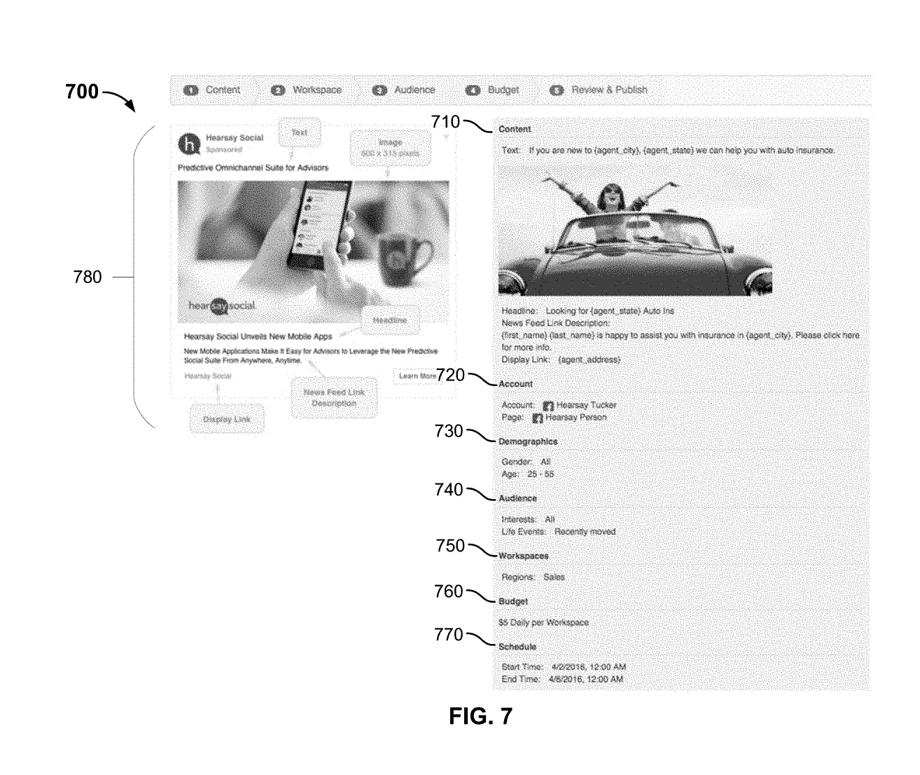

FIG. 7 illustrates an example of a review and publish screen. In the example shown, the screen 700 displays the content 710 created, the account 720 associated with the content, the demographics 730 associated with the content, the audience 740 associated with the content, the workspaces or nodes 750 associated with the content, the budget 760 associated with the content, and the schedule 770 associated with the content.

The content 710 corresponds to the information entered into the template 600 in FIG. 6A and provides the creator user with the opportunity to review the composed web document for any errors before the web document is published.

The account 720 identifies an account associated with a creator user and one or more pages associated with a publisher user to which the web document will be published. For example, a creator user may be an individual within an organization that creates web documents for a set of elements of the organization. A publisher user may be one of the elements within an organization that is capable of posting web documents for the organization on websites (e.g., the publisher user's Facebook® page, the publisher user's Twitter® page, the publisher user's LinkedIn® page, the publisher user's Google+® page) associated with the publisher user. In the example shown, the creator user Hearsay Tucker has composed a web document that will be published to Hearsay Person's Facebook® account.

The demographics 730 identify one or more groups for which the web document will be published. For example, the one or more groups may include gender, age, race, ethnicity, political affiliation, religious affiliation, education level, marital status, household income, etc. In the example shown, the web document will be published to individuals of both genders that are between the ages of 25 and 55.

The audience 740 identifies one or more targeted groups for which the web document will be published. For example, the one or more targeted groups may include interests, life events, etc. In the example shown, the web document will be published to individuals that have recently moved.

The workspaces 750 identify the one or more nodes selected at step 412. The budget 760 identifies the amount of money that will be spent per workspace. The schedule 770 identifies a start time of when the web document will begin to be published to the website(s) associated with the publisher user and an end time of when the web document will no longer be published to the website(s) associated with the publisher user. In the example shown, the content 710 will be published to Hearsay Person's Facebook® page from 12:00 am on Apr. 2, 2016 until 12:00 am on Apr. 6, 2016.

The sample 780 depicts a sample web document, which illustrates where different fields of the template 600 will appear on the website. In the example shown, the Text field will appear above the selected image. The Headline field will appear below the selected image and the News Feed Link Description field will appear below the Headline field. The Display Link field will appear at the bottom of the web document.

Upon clicking the “Publish” button (not shown), the content 710 will be published to a website associated with each element to which the content is associated. In some embodiments, a check will be performed to see if the created content is valid for all of the elements associated with the selected node since the content was created. In some embodiments, the elements of the node will include additional elements since the web document was composed.

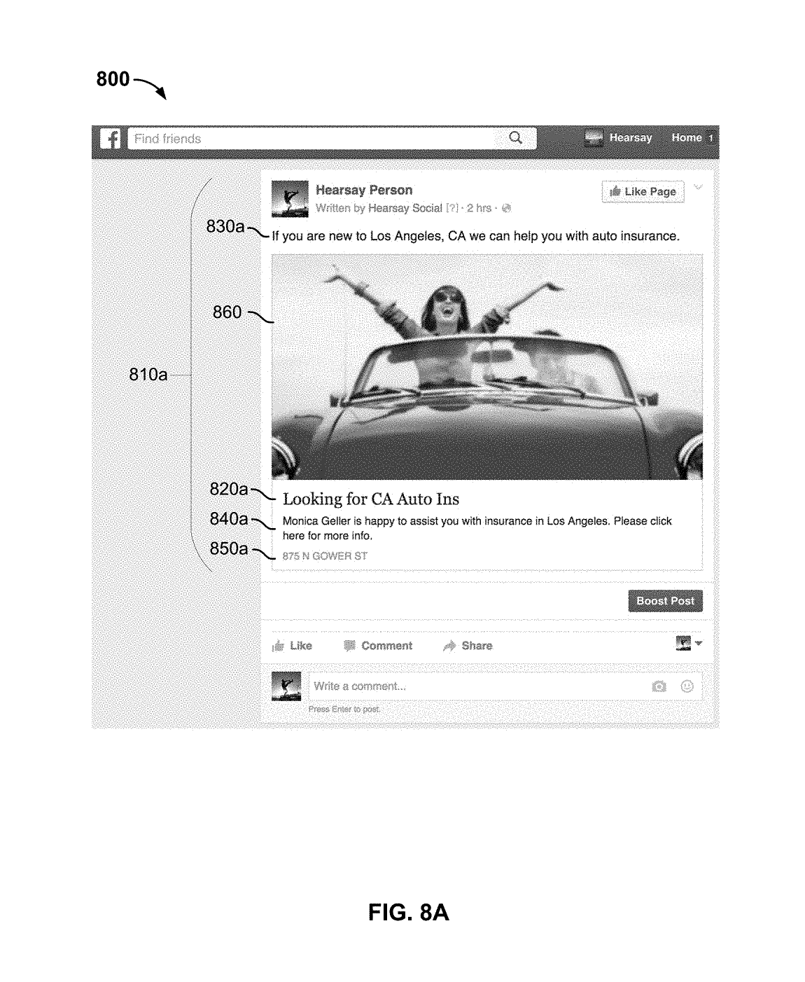

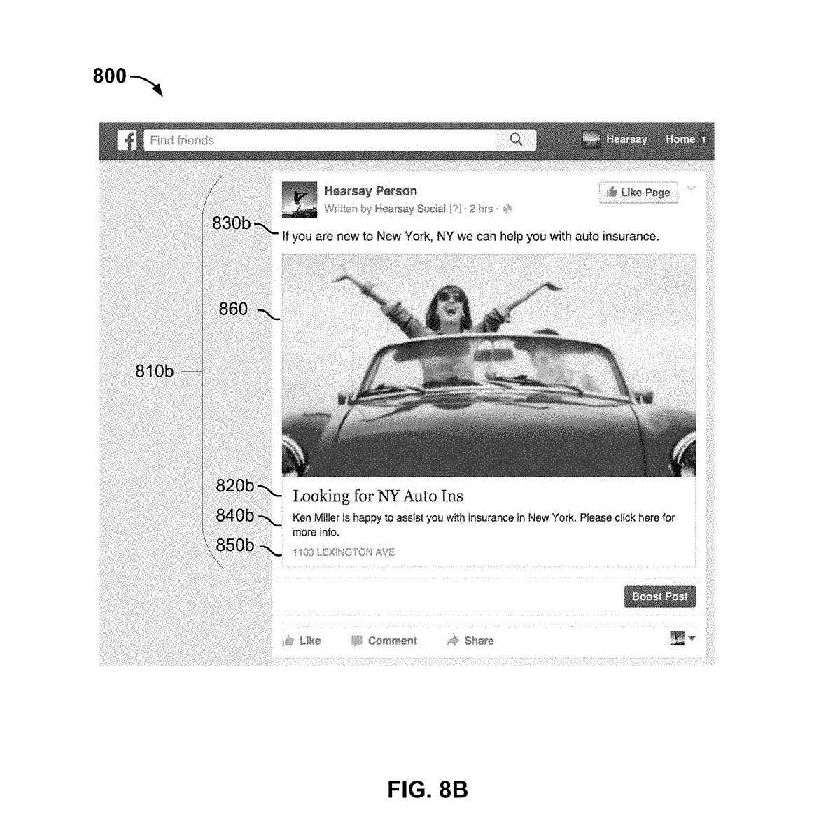

FIGS. 8A and FIG. 8B illustrate examples of content created for elements of a selected node. In the examples shown in 800, the documents 810a and 810b are created for elements 350 and 370, respectively. As seen in the examples shown, documents 810a, 810b include text, tags, and an image that were inputted using the template. The text associated with different fields is located at a particular location of the web document. In some embodiments, the number of characters of text for a particular field is determined based on the particular location of the web document. The number of characters of text for a particular field should not exceed the character count limit of that particular field to ensure proper formatting of the web document.

For example, the web document 810a has a headline 820a of “Looking for CA Auto Ins,” which corresponds to the text “Looking for {agent_state} Auto Ins” entered into Headline field 620. As seen in 810a, the web document creation platform replaced the token “{agent_state}” with the entry value 324c for element 350.

The web document 810a has text 830a of “If you are new to Los Angeles, Calif. we can help you with auto insurance.” Text 830a corresponds to the text “If you are new to {agent_city}, {agent_state} we can help you with auto insurance” entered into Text field 630. As seen in 810a, the web document creation platform replaced the tokens “{agent_city}” and “{agent_state}” with the entry values 322c and 324c, respectively, for element 350.

The web document 810a has text 840a of “Monica Geller is happy to assist you with insurance in Los Angeles. Please click here for more info.” Text 840a corresponds to the text “{first_name} {last_name} is happy to assist you with insurance in {agent_city}. Please click here for more info.” entered into News Feed Link Description field 640. As seen in 810a, the web document creation platform replaced the tokens “{first_name}”, “{last_name}”, and “{agent_city}” with the entry values 312c, 314c, and 322c, respectively, for element 350.

The web document 810a has text 850a of “875 N. Gower St.” Text 850a corresponds to the text “{agent_address}” entered into the Display Link field 650. As seen in 810a, the web document creation platform replaced the tokens “{agent_address}” with the entry value 320c for element 350.

In the example shown, the web document 810a has an image 860 that corresponds to the image selected at Image field 660.

Web document 810b is a second web document composed using the template 600. In the example shown, the text of the web document 810b is the same as web document 810a except that the tokens in the associated fields have been replaced with entry values associated with element 370. The image 860 used for web document 810b is the same image that is used for web document 810a.

An efficient web document creation technique has been disclosed. The web document creation technique creates a template that may be used for many elements. By taking into consideration the amount of information about an organization's elements and a particular website's constraints, a web document creation platform is able to use the template and publish the web document for all of the selected elements at the same time.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a user selection of one or more nodes of a hierarchical data structure, a node of the one or more nodes comprising a set of one or more elements, and the selected one or more nodes comprising a plurality of elements;
determining a plurality of available tokens associated with the one or more selected nodes based at least in part on metadata associated with the plurality of elements, an available token corresponding to an entry common to each of the plurality of elements of the selected one or more nodes;
determining a plurality of character lengths corresponding to the plurality of available tokens, the determination being based at least in part on a character length of an entry value;
receiving a user input of content for a field in a template, the field being associated with a character count limit, the user input comprising at least one of the determined plurality of available tokens;
dynamically updating a character count associated with the user input based at least in part on a corresponding character length of the available token inputted by a user; and
causing a plurality of documents to be composed, the plurality of documents corresponding to the plurality of elements associated with the one or more selected nodes, and each of the plurality of documents being composed based at least in part on the inputted available token and the entry value corresponding to the inputted available token.

2. The method of claim 1, wherein an element is capable of being associated with more than one node of the one or more nodes.

3. The method of claim 1, wherein the plurality of available tokens associated with the one or more selected nodes is displayed to the user.

4. The method of claim 1, wherein the metadata associated with the one or more selected nodes is periodically computed and stored in the hierarchical data structure.

5. The method of claim 1, wherein dynamically updating the character count associated with the user input based at least in part on the corresponding character length of the available token inputted by the user includes:
updating the character count associated with the user input as the available token is being inputted by the user; and
updating the character count associated with the user input to reflect an actual character count when the user has completed inputting the available token.

6. The method of claim 1, further comprising notifying the user if the character count exceeds the character count limit associated with the field.

7. The method of claim 1, further comprising notifying the user if the character count exceeds the character count limit associated with the field, wherein the user is notified when the user selects a different field in the template.

8. The method of claim 1, further comprising notifying the user if the character count exceeds the character count limit associated with the field, wherein the user is notified when the user attempts to proceed to a next portion of a document creation workflow.

9. The method of claim 1, further comprising verifying the plurality of documents at least in part by determining for each element of the plurality of elements whether each field of the template satisfies a character length requirement.

10. The method of claim 1, further comprising:
verifying the plurality of documents at least in part by determining for each element of the plurality of elements whether each field of the template satisfies a character length requirement; and
sending the verified documents to be published on a website.

11. The method of claim 1, further comprising:
verifying the plurality of documents at least in part by determining for each of an updated set of one or more elements whether each field in the template satisfies a character length requirement;
in the event the plurality of documents are not verified, identifying an element of the updated set of one or more elements that does not conform to a requirement of the template; and
providing an interface to the user to modify an invalid field in the template associated with the identified element.

12. The method of claim 1, further comprising:
verifying the plurality of documents at least in part by determining for each of an updated set of one or more elements whether each field in the template satisfies a character length requirement;
in the event the plurality of documents are not verified, identifying an element of the updated set of one or more elements that does not conform to a requirement of the template; and
receiving an input from the user to publish the documents for the elements of the updated set of elements except for the identified element.

13. A system, comprising:
a processor configured to:
receive a user selection of one or more nodes of a hierarchical data structure, a node of the one or more nodes comprising a set of one or more elements, and the selected one or more nodes comprising a plurality of elements;
determine a plurality of available tokens associated with the one or more selected nodes based at least in part on metadata associated with the plurality of elements, an available token corresponding to an entry common to each of the plurality of elements of the selected one or more nodes;
determine a plurality of character lengths corresponding to the plurality of available tokens, the determination being based at least in part on a character length of an entry value;
receive a user input of content for a field in a template, the field being associated with a character count limit, the user input comprising at least one of the determined plurality of available tokens;
dynamically update a character count associated with the user input based at least in part on a corresponding character length of the available token inputted by a user; and
cause a plurality of documents to be composed, the plurality of documents corresponding to the plurality of elements associated with the one or more selected nodes, and each of the plurality of documents being composed based at least in part on the inputted available token and the entry value corresponding to the inputted available token; and
one or more memories configured to provide the processor with instructions.

14. The system of claim 13, wherein an element is capable of being associated with more than one node of the one or more nodes.

15. The system of claim 13, wherein the metadata associated with the one or more selected nodes is periodically computed and stored in the hierarchical data structure.

16. The system of claim 13, wherein to dynamically update the character count associated with the user input based at least in part on the corresponding character length of the available token inputted by the user, the processor is further configured to:
update the character count associated with the user input as the available token is being inputted by the user; and
update the character count associated with the user input to reflect an actual character count when the user has completed inputting the available token.

17. The system of claim 13, wherein the processor is further configured to notify the user if the character count exceeds the character count limit associated with the field.

18. The system of claim 13, wherein the processor is further configured to verify the plurality of documents at least in part by determining for each element of the plurality of elements whether each field of the template satisfies a character length requirement.

19. The system of claim 13, wherein the processor is further configured to:
verify the plurality of documents at least in part by determining for each element of the plurality of elements whether each field of the template satisfies a character length requirement; and
send the verified documents to be published on a website.

20. A computer program product, the computer program product being embodied in a non-transitory computer readable storage medium and comprising computer instructions for:
receiving a user selection of one or more nodes of a hierarchical data structure, a node of the one or more nodes comprising a set of one or more elements, and the selected one or more nodes comprising a plurality of elements;
determining a plurality of available tokens associated with the one or more selected nodes based at least in part on metadata associated with the plurality of elements, an available token corresponding to an entry common to each of the plurality of elements of the selected one or more nodes;
determining a plurality of character lengths corresponding to the plurality of available tokens, the determination being based at least in part on a character length of an entry value;
receiving a user input of content for a field in a template, the field being associated with a character count limit, the user input comprising at least one of the determined plurality of available tokens;
dynamically updating a character count associated with the user input based at least in part on a corresponding character length of the available token inputted by a user; and
causing a plurality of documents to be composed, the plurality of documents corresponding to the plurality of elements associated with the one or more selected nodes, and each of the plurality of documents being composed based at least in part on the inputted available token and the entry value corresponding to the inputted available token.
